(19) United States
(12) Patent Application Publication
(10) Pub. No.: US 2026/0243655 A1
(43) Pub. Date: Aug. 20, 2026

(54) METHOD AND DEVICE FOR INTERFEROMETRIC MICROSCOPY

(71) Applicant: Holtra AB, Göteborg (SE)

(72) Inventors: Fredrik Eklund, Göteborg (SE); Erik Olsén, Mölndal (SE); Daniel Midtvedt, Romelanda (SE)

(21) Appl. No.: 19/162,594

(22) PCT Filed: Mar. 6, 2024
(86) PCT No.: PCT/SE2024/050209

§ 371 Date: Sep. 5, 2025

(30) Foreign Application Priority Data
Mar. 6, 2023 (SE) 2330114-6
Aug. 9, 2023 (SE) 2330349-8

(51) Int. Cl. G01N 15/1434; G01N 15/0227; G01N 15/1404

(52) U.S. Cl. CPC G01N 15/1436; G01N 15/0227; G01N 15/1404

(57) ABSTRACT

A sample holder and a method for using such a holder in interferometric microscopy. The sample holder is designed such that the height of a sample chamber is similar or smaller than the coherence length of the illuminating light, said sample chamber having a floor and a roof defining therebetween an internal height of the sample chamber. The sample chamber further has a lower interface formed between an inner space of the sample chamber and the floor and an upper interface formed between the inner space of the sample chamber and the ceiling. The internal height is in a viewable area of the sample chamber designed such that light from the reflection from the chamber lower interface and light from the reflection from the chamber upper interface is sufficiently out of phase such that destructive interference of the two reflections is achieved.

### FIELD OF THE INVENTION

The invention relates to a method and a device for characterizing submicron-and nanoparticles by the use of interferometric microscopy. In particular, the invention relates to a sample holder and sample chamber to be used in interferometric microscopy.

### BACKGROUND OF THE INVENTION

Interferometric microscopy here broadly means microscopy methods which utilize the principle of interference of light to enhance contrast and/or extract more optical information than in conventional brightness contrast microscopy methods. Interferometric scattering microscopy (ISCAT) is a subset of interferometric microscopy methods, which is most commonly utilized for imaging of biological particles smaller than the wavelength of light and most commonly nanoparticles, such as viruses, proteins, extracellular vesicles. Although other configurations are possible, interferometric scattering microscopy is most commonly implemented for backscattered light, where the liquid sample (comprising dispersed particles) on a coverslip or in a microfluidic channel is illuminated by light directed towards the sample through the microscope objective and where light scattered by the particles interfere with light reflected back through the objective by the glass-liquid sample interface.

### SUMMARY

The invention relates to an interferometric microscopy system for characterizing submicron-and nano-particles. According to a first aspect of the invention, there is provided an interferometric microscopy system for characterizing submicron-and nano-particles, the system comprising: a sample holder comprising a chamber configured to hold a liquid sample comprising at least one particle, said sample holder having a floor and a roof; wherein at least the floor is optically transparent; a light source configured to illuminate said liquid sample through the floor of the sample holder, the illuminating light having a coherence length of similar length or longer than a height of the chamber, a detector arranged to record images of light backscattered by the at least one particle in the sample, said detector being closer to the floor than the roof, wherein reflected light from a chamber lower interface between the floor and the sample due to difference of refractive index between the chamber floor and the sample as well as reflected light from the chamber upper interface between the sample and the ceiling due to difference of refractive index between the sample and the roof is reflected back to the detector where the reflected light interferes with light backscattered by the at least one particle in the sample, and wherein the height of the chamber in the field of view is nλ/4±λ/6, where n is an odd integer 1, 3, 5, . . . and λ is the wavelength of light in the liquid sample such that light from the reflection from the chamber lower interface and from the reflection from the chamber upper interface reaching the detector is sufficiently out of phase to achieve destructive interference.

The system includes a sample holder for holding a liquid sample comprising at least one particle. The sample holder comprises a chamber having a floor and a roof. The chamber may be in the shape of a microfluidic channel, through which sample may flow during measurement, or a closed chamber of various shapes where the sample may be static during measurement. The floor and preferably the roof are made from a transparent or translucent material. The part of the roof being in contact with the sample is referred to as upper chamber interface while the uppermost part of the roof is referred to as roof top or upper external interface. The region where the roof is in contact with the sample, i.e. the ceiling, will be referred to as the chamber upper interface and the region where the floor is in contact with the sample will be referred to as the lower chamber interface. In the present context, the floor thereby refers to the entire volume of the sample holder between the lower interface of the chamber and a lower outer surface of the sample holder, and the roof analogously refers to the entire volume of the sample holder between the upper interface of the chamber and an upper outer surface of the sample holder. Moreover, “ceiling” and “upper interface” may be used interchangeably in the following description.

The optical system and the sample holder may be placed at any angle, such as horizontally or upside down, but for the purpose of this description, the part closest to the microscope objective is always designated the floor and the part on the far side of the sample from the objective is the roof. It is advantageous to let the sample flow through a channel while being imaged. One advantage is that more particles and a larger sample volume can be imaged during a given time frame. Another advantage is that it is easier to compensate for and remove a speckly background if the background remains static while the particles are moving a substantial distance between each image frame such that they are not subtracted from themselves using temporally adjacent images for background subtraction.

The method further includes the use of a light source for illuminating the liquid sample comprising at least one particle. The illuminating light has a coherence length of similar length or longer than an internal height between the lower chamber interface and the upper chamber interface. The coherence length of light is the propagation distance over which the coherence of the light wave significantly decays. The coherence length depends on the bandwidth in frequency or wavelength of the light, the greater the bandwidth over which the light temporally varies, the shorter the coherence length. The coherence length can therefore be estimated based on the bandwidth of a light source. Different types of laser light sources can have coherence lengths with magnitudes from micrometres to kilometres.

Concerning the liquid medium, particles dispersed in water are most commonly analysed, but particles dispersed in a wide variety of different liquids can be analysed. The method may for example be used for characterizing particles within a cell wherein the cytosol is the liquid in which different particles of interest may be studied. Cytosol is the gelatinous liquid that fills the inside of a cell which is composed of water, salts, and various organic molecules. Cytoplasm comprises, in addition to cytosol, organelles and other particles which in many cases are of interest to be studied. By particles is meant to include a wide variety of different substances and the term is meant to include clusters or agglomerates comprised of same or different molecules or subparts to form the particle. Gaseous bubbles can also be regarded as particles in a liquid media. In a broad interpretation of the term particle, any concentrated substance comprised in the liquid having a refractive index differing from the refractive index of the liquid can be considered to be a particle, e.g. oil droplets in an aqueous solution. However, in most cases the particles consist of or at least comprise a rigid supporting structure.

The method also includes the use of a detector such as a camera arranged to record images of light backscattered by particles in the sample. Backscattering is meant to include light which is scattered by the particle and return through the floor to the detector. The backscattered light to be detected can be light which is scattered to be in antiparallel direction in relation to the incident light or being more or less angled relative the incident light. By antiparallel is meant parallel but moving in opposite direction.

When light is emitted from the light source in direction towards a sample in the sample holder, there will be reflected light from the chamber lower interface due to difference of refractive index between the chamber lower interface and the sample. There will also be reflected light from the chamber upper interface due to difference of refractive index between the sample and the ceiling/roof. Reflected light from these interfaces will be reflected back to the detector (camera) and interfere with light backscattered by the at least one particle in the sample. The reflected light can be used to interfere with light scattered by the particle at the detector. However, it shall be avoided that the reflected light is too strong since the scattered light intensity is in general rather weak and it is risk that the scattered light, which comprises information concerning the particle scattering the light, will be too weak in relation to the reflected light. There is thus a desire to control the relative intensities of scattered light and reflected light. In many cases, the interference will work satisfactorily when the intensities of scattered and reflected light are of the same magnitude.

If light is reflected from different locations, light from these locations may interfere with each other, either positively/constructively or negatively/destructively. In the case of destructive interference, the amplitude of reflected light may be reduced such that the intensity of reflected light is lower than the intensity of either of the two reflections. In this case, there will at least be reflections from the chamber upper interface and the chamber lower interface. Destructive or constructive interference of the two reflections may be advantageous in different cases. For a given illumination intensity of the sample and a given exposure time of the camera, particles will be more detectable and easier to characterize in the case of constructive interference. Constructive interference may be advantageous for large and/or strongly scattering particles. However, reducing the intensity of the reflected light allows to increase the illumination intensity and/or the exposure time and thus enable detection of smaller particles. With increased illumination intensity, the intensity of scattered light from the particles increases, but also the intensity of reflected light may then increase which makes detection of the scattered light from particles remaining difficult. Using destructive interference to reduce the intensity of reflected light enables to keep the intensity of scattered light from particles and the intensity of reflected light at a similar magnitude at higher illumination intensities and/or exposure times, thus enabling detection of smaller and/or more weakly light scattering particles.

In order to achieve reduction or extinction of the reflected light, the height of the chamber in the field of view shall be such that detected light from the reflection from the chamber lower interface and from the chamber upper interface is sufficiently out of phase such that destructive interference of the two reflections is achieved. The field of view is the area/plane in the sample, perpendicular to the optical axis, which is recorded by the detector and within which scattered light is analysed. Another name for this location could be area to be recorded. Particles in the field of view will scatter light to be detected by the detector or camera and the particles subjected to light will be analysed from their interaction with light and their scattering properties. In order to achieve a desired analysis, the height of the chamber should be adapted to the wavelength of the light used. It shall be noted that it is the wavelength of the light in the media in the chamber which is of interest and not the wavelength in air. Hence, the height of the chamber shall be adapted to the wavelength such that the reflection from the chamber lower interface and the reflection from the chamber upper interface is sufficiently out of phase such that destructive interference of the two reflections is achieved. By destructive interference is meant that the reflected light from both the chamber lower interface and the chamber upper interface interfere with each other such that the resulting light from both these reflections will be weaker than the strongest, reflected light beam. In case the intensity of the two reflections is the same, this destructive interference will occur if the phase difference is more than +−120 degrees and preferably the phase difference is more than 150 degrees. If the phase difference is 180 degrees, the resulting light beam of reflected light will be the intensity of the strongest reflected light beam minus the intensity of the weakest reflected light beam. In case both light beams have the same intensity, the reflected light beam will be completely extinguished.

In order to provide a field of view in the chamber which will work for a wide range of light with different wavelength, and different liquid media which affects and interacts differently with light and influences the wavelength of light differently, the chamber can be designed such that the height of the chamber varies and thus also areas of constructive and destructive interference between the two reflections are found across the viewable area of the chamber.

The chamber may be designed such that the upper chamber interface (ceiling) is sloping diagonally and the height difference is at least one wavelength per 3 times the width of the field of view and less than 30 times the width of the field of view. A practical example could be that the field of view in the sample is 100 micrometres wide and the height difference between two points in a chamber is three times that (300 micrometres) is at least one wavelength, which for green light in water is about 0.4 micrometre. Instead of a flat sloping ceiling it is technically possible, to use a curved ceiling surface to achieve the same effect even though a sloping ceiling normally is preferred.

The chamber can be designed such that the height of the chamber is gradually altered or such that the height of the chamber is altered stepwise. The chamber can for example be designed to have regions which changes 50 nanometres in height stepwise. In order to find a suitable location, the field of view can be moving along or across the chamber before measurement, to find an area where a desired interference occurs. In the case of destructive interference, this will be achieved when the reflected light beams have a phase difference from at least +/−90 degrees to +/−180 degrees and the minimum will be at +/−180 degrees where the two reflections are out of phase. Destructive interference is thus achieved when the chamber height is nλ/4 where n is an odd integer 1, 3, 5, . . . and λ is the wavelength of light in sample. Since some reflected light is needed for scattered light to interfere with, it is not desirable to completely remove the reflections by perfectly destructive interference. Rather it is desirable to achieve partially destructive interference by letting the height defined above vary within a range of ±λ/6 in order to achieve a phase difference between the reflections in the range 180±60 degrees.

An alternative method for control of interference is to provide a roof which is mobile relative to the floor and before measurement mechanically adjust the distance between the ceiling (upper chamber interface) and the floor (lower chamber interface) of the chamber to control the interference in order to achieve a suitable degree of destructive or constructive interference between the light reflected from the two interfaces. However, this requires additional equipment and may be more costly.

The height of the chamber can for example be from at least 2 wavelengths, or about 1 micrometre, up to 3200 wavelengths, e.g. about 2 millimetres. However, in practice, the height is more preferably less than 100 wavelengths or less than 50 micrometres. Chambers being within the interval of 10 to 100 micrometres are suitably used. If the chamber is a channel and the height is too small, the flow through the channel may be hard to control, the sample throughput may be limited and there may be clogging problems restricting the flow. However, it can be easier from a manufacturing point of view to control the exact height of the entire channel/chamber for small dimensions.

An alternative method to reduce undesired interference could be to use deeper channels, combined with a coherence length of light which is shorter than the channel depth. For example, a coherence length of about 50 μm combined with channels which are about 100 μm deep or more. This would avoid any interference between the two reflections, constructive or destructive. But deep chambers may give background noise from particles out of focus instead and the one reflection from an interface which does not interfere with the particles will still give an additional background light which to some extent obscures the scattered light and interfering light of interest. Hence, depending on which parameters that are considered most important, the maximum and minimum height of the chamber may vary.

Even though chambers having a constant height may be used and adapted to suit a particular purpose with known liquid media and specific wavelength of the light to be used, chambers having a variation in its height are preferably used since media with different RI can be used and an optimum height can always be found. If a fixed height is used, adapted to water, other media will not work in most cases as the wavelength is different in different media.

In addition to control the reflections in the chamber lower interface and the chamber upper interface to interfere as desired, e.g. destructively interfering, there may be further undesired reflections which is desired to avoid and methods to reduce such reflections may be used together with adapting the height of the chamber to the wavelength of the light used. Using an objective with index-matched oil between the sample holder and the objective will effectively reduce reflections involving these two surfaces. However, an undesired reflection often comes from the lenses inside the objective. Furthermore, when using a transparent roof on the chamber, reflections may come from the interface between the top of the roof and air.

One way to avoid reflection emanating from outside the chamber is to offset the illumination light beam relative to the optical axis of the objective lens and/or directed at an angle relative to the optical axis of the objective lens. Such an arrangement will cause the illumination light to illuminate the sample at an angle relative to the optical axis. Avoiding back reflection from the objective and the top of the roof may thus be achieved by aligning illumination such that the sample is illuminated at an angle, such that the reflections from objective lens, chamber lower interface, the chamber upper interface and roof top of chamber does not appear on top of each other at the detector (camera).

Another method to reduce reflection is to design the chamber roof to be transparent and having a thickness of at least 1 mm, preferably at least 3 mm. This will enhance the effect of aligning the illumination of the sample at an angle, concerning the reflection from the top of the roof. The thicker the roof, the easier to avoid the reflection from being in the field of view. Similarly, a large distance between the objective lens and the sample will also facilitate avoiding the objective reflection in the field of view.

The back reflection from the objective or from the roof top could also be blocked from reaching the detector by placing a spatial filter in a focal plane. Again, with a long distance between the source of the unwanted reflection and the sample, the reflection will be focused in a subsequent focal (Fourier) plane which is at a substantially different axial position along the optical path than the focused light from the sample and the wanted reflection from the chamber. This enables to remove the unwanted reflection with the help of a spatial filter, while avoiding to remove the wanted light.

Another way to avoid reflection from the roof top is if the roof top has an optical coating which causes less light to be reflected from the surface than without the coating. This can be combined with other measures.

Yet another way to avoid reflection from the roof top is if the roof top is designed to have an angle such that it is not at 90 degrees to the optical axis of the objective lens. This can cause the reflection to be reflected to outside the field of view. This can be combined with other measures.

Using a sample holder where the liquid sample is covered by a transparent roof has the advantage that backscattering interferometric microscopy can be combined with other microscopy methods which utilize light transmitted through the sample. Such a transmission-based method, which analyse the forward scattered light from particles in the sample, is digital holographic microscopy (DHM). In particular, DHM can achieve an enhanced sensitivity when complemented with a partially light transparent spatial filter (Twilight filter) in a focal plane.

Above described methods could be used for combining interferometric backscattering microscopy with twilight holographic microscopy by placing the focal plane of the holographic image and the focal plane of the backscattering top reflection and/or the objective back reflection at different axial, as well as possibly lateral, positions along the optical path, enabling use of separate spatial filters for removal of unwanted back reflections from the light source for interferometric backscattering and for dampening of the illumination background in holographic microscopy, respectively.

There are additional methods to remove unwanted reflections, but which makes combination with DHM and other methods difficult. For example, the roof top could have a highly curved surface in order to reflect light in many different directions and thereby decrease the back reflection affecting the field of view. However, such a curved surface would severely distort the holographically captured images. Similarly, the interior upper interface (ceiling) of the chamber could be strongly curved to remove much of the reflection, but this may also distort the simultaneous holographic microscopy image.

Furthermore, there could be an optical coating on either the upper or the lower interface of the chamber in order to only have one reflection as reference for the light scattered by the particle. However, this may be more costly to manufacture and such a coating may need to be optimised for a specific liquid media. Standard antireflection coatings are optimised for glass/air interfaces.

The invention also relates to an interferometric microscope comprising
a light source for illuminating a sample
a sample holder for holding a sample to be illuminated comprising a microchamber for a liquid sample,
a detector such as a camera arranged to record images of light scattered by (particles in) the sample, said detector located to detect backscattering
the illuminating light has a coherence length of the same length or longer than the internal height of the chamber, and
the height of the chamber in the field of view is related to the wavelength of light in the sample, such that the reflection from the ceiling and the reflection from the floor is sufficiently out of phase that destructive interference of the two reflections is achieved.

There are still other alternatives which may be used to avoid back reflections. One method to avoid unwanted back reflections from both the ceiling and the roof top of the sample chamber is to let only the floor be of a transparent and somewhat reflective material, such as glass, whereas the roof is of a nonreflective and non-transparent material, for example something that is matte and black. There are two disadvantages with this; first, it does not enable using additional imaging methods with illumination from above. Second, matte and dark materials of for example plastic or rubber material often are more prone to adsorption of particles in the sample than for example smooth and hydrophilic surface of glass or quartz.

An alternative embodiment of the invention is to let the ceiling be reflective (and thus the ceiling and floor reflections need to be out of phase) but the roof being of a non-transparent material, for example coloured glass. Yet another alternative is to let the roof be of a reflective and transparent material such as glass, but cover the top with an opaque nonreflective material. This could be matte black paint, or if the material is quartz/silicon it can be surface modified to be matte black-something which is known as black silicon.

Glass and quartz are advantageous materials for several reasons. They are optically homogeneous. They have surfaces which are smooth and hydrophilic and therefore more passive against adsorption than many polymer materials. They are compatible with and resistant against many different liquids, solvents as well as acids and bases.

Whereas interferometric backscattering microscopy if often performed on very small field of view and within a narrow axial range/depth, it is advantageous if a large field of view can be recorded and analysed, and the avoidance of unwanted reflections is of importance to achieve this. Furthermore, utilizing the reflection from both ceiling and floor of the chamber improves the imaging of particles in a deeper volume since the particles create a stronger interference the closer they are to a reflecting surface.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a microscopy set-up for interferometric backscattering microscopy according to an example;

FIGS. 2A-B schematically illustrate a sample holder for interferometric backscattering microscopy;

FIG. 3 schematically illustrates a sample chamber and corresponding reflections in a microscopy set-up for interferometric backscattering microscopy according to an example;

FIG. 4 schematically illustrates a sample chamber and corresponding reflections in a microscopy set-up for interferometric backscattering microscopy according to an example;

FIGS. 5A-B schematically illustrate example sample chambers in a microscopy set-up for interferometric backscattering microscopy;

FIGS. 6A-B schematically illustrate example sample chambers as seen from a detector in a microscopy set-up for interferometric backscattering microscopy according to an example;

FIG. 7 schematically illustrates reflections in a microscopy set-up for interferometric backscattering microscopy; and

FIG. 8 schematically illustrates a microscopy set-up for interferometric backscattering microscopy according to an example.

### DETAILED DESCRIPTION OF EXAMPLE EMBODIMENTS

In the present detailed description, various embodiments of the system and method according to the present invention will be described.

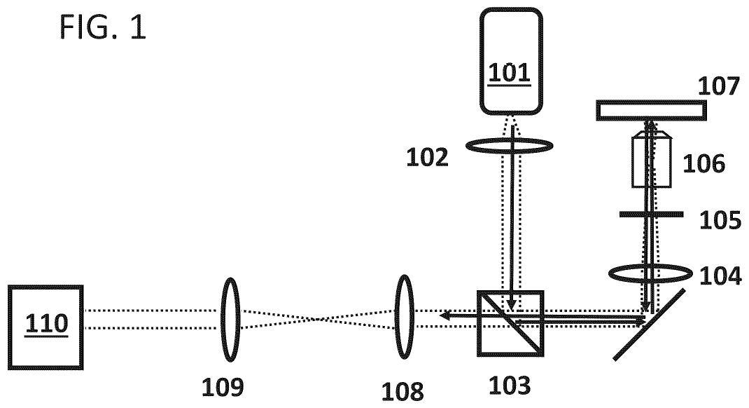

FIG. 1 shows a microscopy set-up for interferometric backscattering microscopy. The set-up comprises a light source 101. The light passes one or several lenses 102 in order to expand the beam and provide a desirable degree of collimation of the light at the sample. The light is further reflected by a beam splitter 103, which is preferably polarization-dependent, and enters the microscope, following the optical path “backwards”. The light passes through the tube lens 104 and is focused at the focal plane of the microscope objective 106 and is collimated when reaching the sample from below. Light reflected by the sample holder, together with light scattered by particles in the sample travels down through the objective and tube lens, passes through the beam splitter towards a camera 110. Optionally, there is quarter-wave plate 105 below/behind the objective in the case of using a polarization selective beam splitter. As light first passes this plate 105 in one direction and then on the way back after having been reflected, it is in total rotated 90 degrees. This enables the very most of the light to pass through the beam splitter and this arrangement limits the light losses in the set-up. One option is to use two lenses 108,109 to create a focal plane where collimated light in the image plane is focused to a small spot. In the focal plane spatial filters may be placed for selective removal of background light.

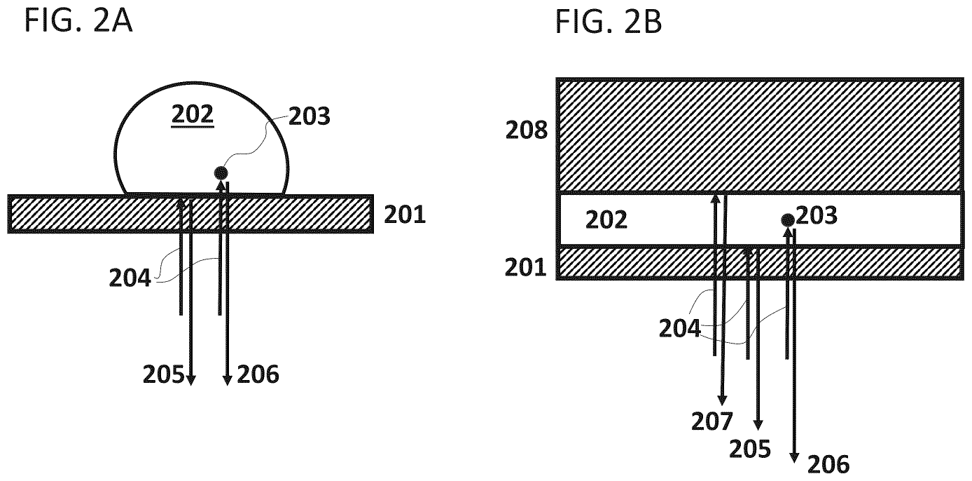

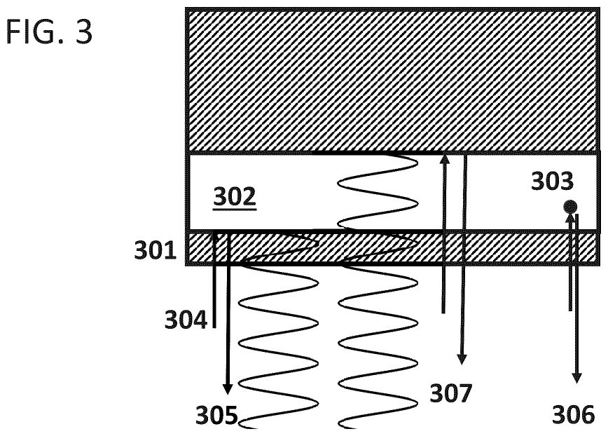

FIG. 2A shows a common type of sample holder for interferometric backscattering microscopy. A glass cover slip used as a floor 201 is placed above the microscope objective. A drop of liquid sample 202 is placed on top of the glass cover slip, said sample 202 comprising a particle 203. Incident light 204 is illuminating the sample and sample holder from below. A minor part of the light is partially reflected backwards from the liquid/glass interface, i.e. lower chamber interface light reflection 205. Incident light 204 is scattered by the particle 203, some of the scattered light is directed backwards as particle light reflection 206.

Due to the difficulties of performing interferometric backscattering microscopy on enclosed samples, due to the many reflections, this simple sample holder is the most common.

FIG. 2B shows a sample holder where the sample 202 is placed in a chamber or channel, having roof 208 and a floor 201. The sample comprises the particle 203. Incident light 204 illuminating the sample holder from below is reflected by the ceiling/upper chamber interface as light reflection 207, by the floor/lower interface 205 as lower chamber interface light reflection 205, and scattered by the particle as particle light reflection 206.

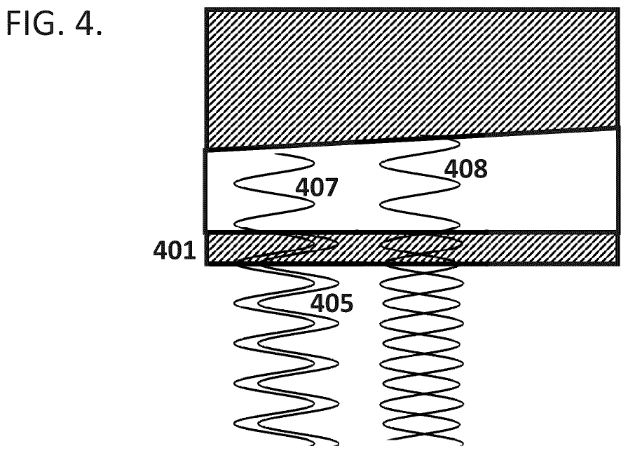

FIG. 3 schematically illustrates a sample holder where the sample 303 is placed in a chamber or channel 302. Incident light 304 illuminate the sample holder from below. Light is scattered by the particle 303 as particle light reflection 306. FIG. 3 further illustrates how floor interface light reflection 305 reflected by the floor/lower interface is in phase with ceiling interface light reflection 307 reflected from the ceiling at the upper interface, due to suitable combination of light wavelength, sample liquid 302 and height of the sample chamber/channel. Note that this is a drawing to show the principle, however in reality the light wave will have different wavelength in the liquid, compared to in the floor 301 and below. Below the floor 301 there is typically index-matched oil between the floor and the objective such that light will have the same wavelength in the floor as well as below the floor. By changing the height of the channel by a quarter of a wavelength, the floor interface light reflection 305 and ceiling interface light reflection 307 will be completely out of phase.

FIG. 4. Illustrates a sample chamber/channel where the ceiling is sloping such that the height is non-uniform. At a first position, light reflected by the ceiling/upper interface as ceiling interface light reflection 407 is in phase with light reflected by the floor/lower interface 401 as floor interface light reflection 405. At a second position, light reflected by the ceiling as a second ceiling interface light reflection 408 is not in phase with light reflected by the floor and there is destructive interference between the two reflections.

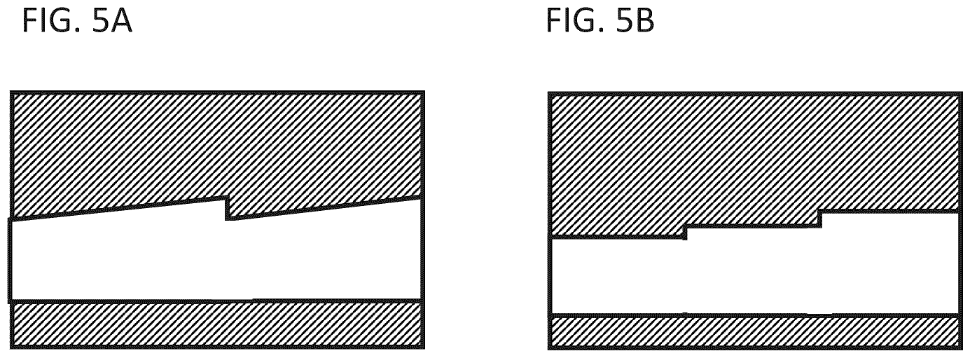

FIG. 5A. illustrates a variation of the chamber height with a saw tooth profile, allowing the channel to have a more uniform height over a longer distance, while small variations allow areas of constructive and destructive interference to be found.

FIG. 5B illustrates a chamber with varying height in a stepwise manner, with a staircase profile. This can allow for the height to be more uniform within the field of view while still allowing different areas of the chamber to have different height.

Several more ways to have a varying chamber height can be envisioned.

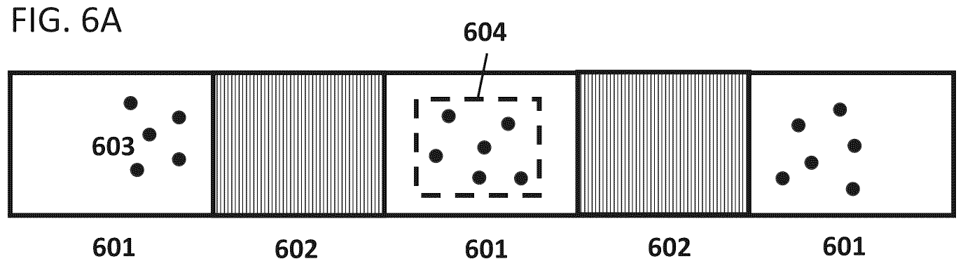

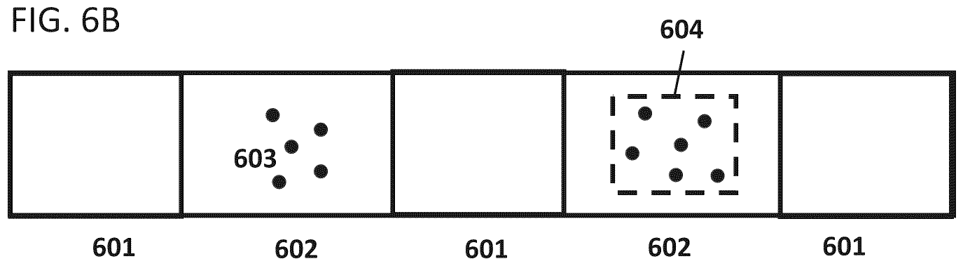

FIG. 6A Illustrates an elongated sample chamber as it can be viewed from the detector. This sample chamber in the form of an elongated channel has a varying height due to the ceiling sloping along the length of the channel. This causes alternating areas of constructive interference 601 and destructive interference 602 interference between the reflection from the ceiling/upper interface and floor/lower interface. In the areas with constructive interference 601 the background appears brighter and when parameters such as illumination intensity and/or exposure time are optimized for these regions, particles in the sample are visible due to interference of scattered light with reflected light. In the areas with destructive interference 602 the background appears darker, and the particles 603 in the sample are not visible at the same illumination intensity and/or exposure time. The field of view 604 is suitably moved to a region of destructive interference before the illumination intensity and/or exposure time is increased before recording images and analyzing particles. At this higher illumination intensity and/or exposure time, the areas with constructive interference will cause overexposure of the camera sensor and thus appear completely white, whereas in the regions with more destructive interference, particles will be visible with an enhanced contrast relative to the first set of parameters. This case is disclosed in FIG. 6B where particles 603 of the sample are visible in the areas of destructive interference 602 but not in the areas of constructive interference 601.

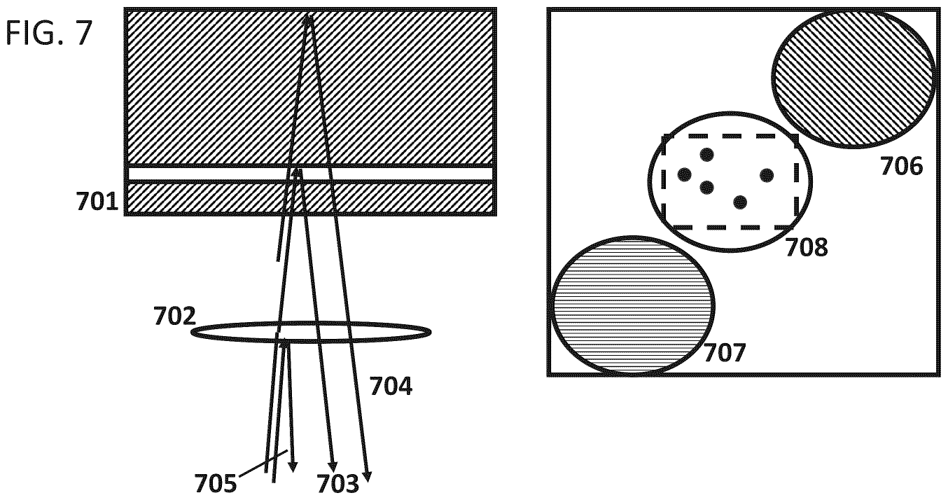

FIG. 7 Illustrates how unwanted reflections from the top of the roof of the channel and from the objective lens or lenses can be avoided in the field of view. The left image shows as in previous figures an elongated sample chamber in the form of a channel having a roof and a floor. The roof is much thicker than the floor, preferably several mm. By directing and focusing the illumination light to a point in the focal plane of the objective off-set compared to the optical axis of the objective, and optionally also at an angle relative to the optical axis, the illumination light will be directed towards the sample holder at an angle compared to the optical axis. This angle is at least one or several degrees. This will cause channel interface light reflection 703 reflected from ceiling and/or floor of the channel to take a different path to the detector than roof top light reflection 704 reflected from the top of the roof and lens light reflection 705 reflected by the objective lens or lenses 702. The right image shows the chamber viewed from the direction of the detector. The reflection from the top of the roof, roof top reflection image 706 and the reflection from the objective lens, lens reflection image 707, are projected on the detector at different positions from the desired reflection image 708 from the upper and lower interface of the chamber and the scattered light from particles in the sample.

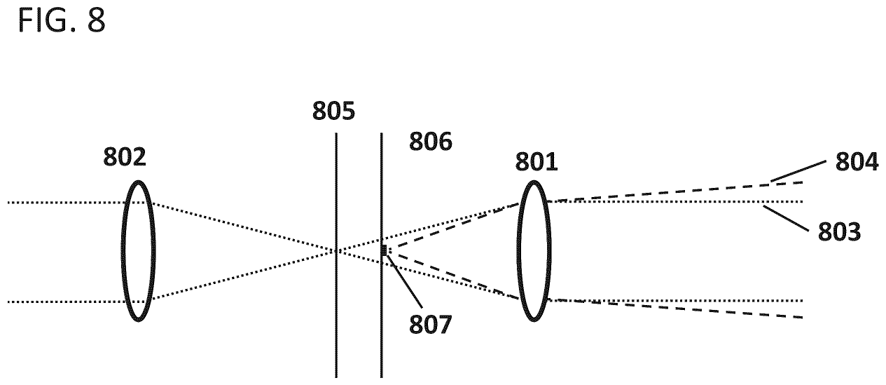

FIG. 8. Illustrates how an unwanted reflection from either the roof top of the sample holder or from the objective lens can be blocked by a spatial filter. This requires that there is a significant distance between the source of the unwanted reflection and the source (upper and/or lower interface) of the sample chamber. Two lenses 801, 802 focus collimated light 803 from the desired image and image background (wanted reflections from chamber) into a focal plane 805 and recollimate the light before it reaches the detector. Roof top light reflection 804 reflected from the roof top (or the reflections from the objective lens) will be somewhat uncollimated when reaching the lens arrangement since it originates from out of focus. This causes this light to be focused at a slightly different focal plane 806. This makes it possible to place a spatial filter 807 at this focal plane to selectively block the unwanted reflection, whereas the majority of the light from the wanted reflection passes this filter. The effect of having the reflections in different focal planes can be enhanced by letting the light reaching the sample holder be somewhat uncollimated, however this will cause distortions in the image which can be detrimental to the analysis. Letting the reflecting surfaces which are sources of unwanted reflections be somewhat curved could also enhance the effect. Letting the roof top be curved may however be detrimental to other imaging methods utilizing illumination from above, through the roof, as these images may be distorted.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An interferometric microscopy system for characterizing submicron-and nano-particles, the system comprising:
a sample holder comprising a chamber configured to hold a liquid sample comprising at least one particle, the sample holder having a floor and a roof; wherein at least the floor is optically transparent;
a light source configured to illuminate the liquid sample through the floor of the sample holder, the illuminating light having a coherence length of similar length or longer than a height of the chamber;
a detector arranged to record images of light backscattered by the at least one particle in the sample, the detector being closer to the floor than the roof,
wherein reflected light from a chamber lower interface between the floor and the sample due to difference of refractive index between the chamber floor and the sample as well as reflected light from the chamber upper interface between the sample and the roof due to difference of refractive index between the sample and the roof is reflected back to the detector where the reflected light interferes with light backscattered by the at least one particle in the sample, and
wherein the height of the chamber in the field of view is nλ/4±λ/6, where n is an odd integer 1,3,5, . . . and 2 is the wavelength of light in the liquid sample such that light from the reflection from the chamber lower interface and from the reflection from the chamber upper interface reaching the detector is sufficiently out of phase to achieve destructive interference.

2. The system according to claim 1, where the roof of the sample holder is transparent.

3. The system according to claim 1, wherein the height of the chamber is varied over the viewable area of the chamber such that there are areas of both constructive and destructive interference between the two reflections in different parts of the viewable area of the chamber.

4. The system according to claim 3, wherein the height of the chamber is gradually varying and the height difference between two laterally separate positions is at least one wavelength per 3 times the width of the field of view and less than 30 times the width of the field of view.

5. The system according to claim 3, wherein the height of the chamber is varying stepwise, and the upper interface for each step is parallel to the lower interface.

6. The system according to claim 3, wherein the sample holder is movable such that the field of view can be moved across the chamber to find an area of destructive interference where the two reflections are approximately out of phase.

7. The system according to claim 1, where the height of the chamber is at least 2 times and less than 300 times the wavelength which the illumination light has in the liquid medium of the sample, more preferably between 2 and 100 times the wavelength of light in the sample.

8. The system according to claim 1, where the illumination light beam is offset relative to the optical axis of the objective lens and/or directed at an angle relative to the optical axis of the objective lens, causing the illumination light to illuminate the sample at an angle relative to the optical axis.

9. The system according to claim 1, where the chamber roof is transparent and the thickness of the chamber roof is at least 1 mm, preferably at least 3 mm.

10. The system according to claim 1, further comprising a spatial filter located in a focal plane and configured to block the back reflection from the chamber roof top from reaching the detector.

11. The system according to claim 1, where the chamber roof top has an optical coating configured to cause less light to be reflected from the surface than without the coating.

12. The system according to claim 1, where the top of the roof of the chamber has an angle such that it is not at 90 degrees to the optical axis of the objective lens, preferably less than 85 degrees and most preferably less than 80 degrees.

13. A sample holder configured to hold a liquid sample comprising at least one submicron- or nano-particle, in an interferometric microscope, the sample holder comprising:
a sample chamber having a floor and a roof, wherein at least the floor is optically transparent, where the height of the sample chamber is similar or smaller than the coherence length of illuminating light, wherein the floor and the roof define therebetween an internal height of the sample chamber, the sample chamber having a lower interface formed between an inner space of the sample chamber and the floor and an upper interface formed between the inner space of the sample chamber and the roof, the internal height is in a viewable area of the sample chamber designed such that when illuminated from below light reflected from the chamber lower interface and light reflected from the chamber upper interface is sufficiently out of phase to achieve destructive interference by letting the height be nλ/4±λ/6, where n is an odd integer 1, 3, 5, . . . and 2 is the wavelength of light in the liquid sample.

14. An interferometric microscope comprising:
a sample holder according to claim 13 holding a sample to be illuminated;
a light source configured to illuminate the sample with illuminating light having a coherence length of similar length or longer than the internal height of the chamber;
a detector arranged to record images of light scattered by particles in the sample interfering at the detector with light reflected by the sample holder;
wherein the internal height of the chamber is in one viewable area of such magnitude that detected light from the reflection from the sample chamber lower interface and from the reflection from the chamber upper interface is sufficiently out of phase to achieve destructive interference by letting the height be nλ/4±λ/6, where n is an odd integer 1, 3, 5, . . . and 2 is the wavelength of light in the liquid sample.

15. The system according to claim 1, wherein the roof of the sample holder is mobile relative to the floor.

16. The system according to claim 15, wherein the roof of the sample holder is mechanically adjustable to adjust a distance between the chamber upper interface and the chamber lower interface.

17. Method for characterizing submicron-and nano-particles using an interferometric microscopy system, the method comprising:
by a light source, illuminating a liquid sample in a sample holder comprising a chamber holding the liquid sample comprising at least one particle, the sample holder having a floor and a roof; wherein at least the floor is optically transparent, wherein the liquid sample is illuminated through the floor of the sample holder and the illuminating light having a coherence length of similar length or longer than a height of the chamber;
by a detector, recording images of light backscattered by the at least one particle in the sample, the detector being closer to the floor than the roof, wherein reflected light from a chamber lower interface between the floor and the sample due to difference of refractive index between the chamber floor and the sample as well as reflected light from the chamber upper interface between the sample and the roof due to difference of refractive index between the sample and the roof is reflected back to the detector where the reflected light interferes with light backscattered by the at least one particle in the sample, and
wherein the height of the chamber in the field of view is nλ/4±λ/6, where n is an odd integer 1, 3, 5, . . . and 2 is the wavelength of light in the liquid sample such that light from the reflection from the chamber lower interface and from the reflection from the chamber upper interface reaching the detector is sufficiently out of phase to achieve destructive interference.

18. The method according to claim 17, further comprising adjusting the degree of destructive or constructive interference between the light reflected from the chamber upper interface and the chamber lower interface by mechanically adjusting a distance between the upper chamber interface lower chamber interface.

19. The method according to claim 17, further comprising moving the field of view across the chamber by moving the sample holder to find an area of destructive interference where the two reflections are approximately out of phase.
